(19) United States
(12) Patent Application Publication
(10) Pub. No.: US 2021/0309309 A1
(43) Pub. Date: Oct. 7, 2021

(54) CONTROL APPARATUS AND CONTROL METHOD

(71) Applicant: SONY CORPORATION, TOKYO (JP)

(72) Inventors: YASUNORI KAWANAMI, TOKYO (JP); YASUHISA KAMIKAWA, TOKYO (JP)

(21) Appl. No.: 17/250,598

(22) PCT Filed: Aug. 7, 2019
(86) PCT No.: PCT/JP2019/031276

§ 371 Date: Feb. 8, 2021

(30) Foreign Application Priority Data
Aug. 16, 2018 (JP) 2018-153165

(51) Int. Cl. B62D 57/028; B62D 57/032; B25J 5/00; B25J 9/00; B25J 9/16

(52) U.S. Cl. CPC B62D 57/028; B62D 57/032; B25J 9/1694; B25J 9/0009; B25J 5/007

(57) ABSTRACT

A control apparatus includes a control unit (29) that controls an orientation of a mobile body (2) equipped with a plurality of leg portions (20) each including at least one joint, each of the leg portions having; a wheel body (2311) that is provided at a leading end of the leg portion and grounds the leg portion; and a pad portion (2312) that is provided on at least one side face of the wheel body and has a higher frictional resistance with respect to a ground surface than that of the wheel body, wherein the control unit controls a braking force that acts on the mobile body from the ground surface by controlling orientations of the leg portions in a pitch axis direction of the mobile body.

### TECHNICAL FIELD

The present disclosure relates to a control apparatus and a control method.

### BACKGROUND ART

In recent years, robots are increasingly used not only in production sites such as factories, or the like, but also in public facilities, living spaces, and so on. For this reason, for example, various robots, such as leg type walking robots that can move on unpaved rough terrain or the like, have been developed.

Here, the leg type walking robots are expected to be a mobile body that is excellent in terrain adaptability since these robots can deal with uneven walking surfaces such as a path in which an obstacle is present or rough terrain, and discontinuous walking surfaces such as stairs or ladders.

However, although the leg type walking robots have high terrain adaptability, the moving speed or efficiency is lower than that of wheel type mobile bodies. This is because, since walking operation is performed by reciprocating operation of leg portions, the energy conversion efficiency of the leg type walking robots is lower than that of the wheel type mobile bodies that can directly convert rotation of a motor to rotation of wheels.

In view of this, leg-wheel type mobile robots that can both walk with legs and travel with wheels have been studied. For example, PTL 1 below discloses a bipedal walking robot with wheels provided on soles of leg portions. The robot disclosed in PTL 1 can both walk with the leg portions and travel with the wheels.

### CITATION LIST

### Patent Literature

[PTL 1]

JP 2006-55972 A

### SUMMARY

### Technical Problem

However, in PTL 1, a brake mechanism for the wheels provided on the soles of the leg portions of the robot is not sufficiently studied.

As brake mechanisms for wheels, disc brakes or drum brakes are commonly used. However, since the disc brakes or the drum brakes are large mechanisms, if a disc brake or a drum brake is used as a brake mechanism for the wheels of the leg portions, the mass and the inertia of the leg portions significantly increase. In such cases, torque required during walking movement with the leg portions increases. Accordingly, the leg-wheel type mobile robots that include a disc brake, a drum brake, or the like for the wheels of the leg portions require more energy during walking movement, and require a larger actuator.

Therefore, there is a need for controlling a braking force for the leg-wheel type mobile bodies using a simpler and lighter mechanism.

### Solution to Problem

According the present disclosure, a control apparatus is provided that includes a control unit that controls an orientation of a mobile body equipped with a plurality of leg portions each including at least one joint, each of the leg portions having; a wheel body that is provided at a leading end of the leg portion and grounds the leg portion; and a pad portion that is provided on at least one side face of the wheel body and has a higher frictional resistance with respect to a ground surface than that of the wheel body, wherein the control unit controls a braking force that acts on the mobile body from the ground surface by controlling orientations of the leg portions in a pitch axis direction of the mobile body.

Also, according to the present disclosure, a control method is provided that includes controlling, with a computing unit, an orientation of a mobile body that includes a plurality of leg portions each including at least one joint, each of the leg portions having; a wheel body that is provided at a leading end of the leg portion and grounds the leg portion; and a pad portion that is provided on at least one side face of the wheel body and has a higher frictional resistance with respect to a ground surface than that of the wheel body, wherein a braking force that acts on the mobile body from the ground surface is controlled by controlling orientations of the leg portions in a pitch axis direction of the mobile body.

According to the present disclosure, friction between the leg portions and the ground surface can be increased by controlling the orientation of the leg portions in the pitch axis direction and changing the ground contact area between the leg portions and the ground to the pad portion that has a higher frictional resistance than that of the wheel body.

### Advantageous Effects of Invention

As described above, according to the present disclosure, a braking force for a leg-wheel type mobile body can be controlled using a simpler and lighter mechanism.

Note that the above effect is not necessarily limited, and any of the effects described in the present specification or other effects that may be understood from the present specification may be achieved together with the above effect, or in place of the above effect.

### BRIEF DESCRIPTION OF DRAWINGS

FIG. 1 illustrates a leg type robot to which the technique according to the present disclosure may be applied.

FIG. 2 is a schematic diagram showing a specific example of a structure of a leg portion of the leg type robot.

FIG. 3A is a perspective view schematically showing the leg portion on which a wheel mechanism is provided.

FIG. 3B is a perspective view schematically showing an example of the wheel mechanism provided on the leg portion.

FIG. 4A is an explanatory diagram schematically showing a wheel used in the technique according to the present disclosure.

FIG. 4B is an explanatory diagram schematically showing a variation of the wheel shown in FIG. 4A.

FIG. 5 is a perspective view schematically showing another example of the wheel used in the technique according to the present disclosure.

FIG. 6 is a perspective view schematically showing a leg-wheel type robot used in the technique according to the present disclosure.

FIG. 7 is a block diagram illustrating a functional configuration of a control apparatus for the leg-wheel type robot.

FIG. 8 is a flowchart diagram illustrating a flow of control of the leg-wheel type robot performed by the control apparatus.

FIG. 9A is a schematic explanatory diagram showing an orientation of the leg-wheel type robot at each point in the flowchart shown in FIG. 8.

FIG. 9B is a schematic explanatory diagram showing an orientation of the leg-wheel type robot at each point in the flowchart shown in FIG. 8.

FIG. 9C is a schematic explanatory diagram showing an orientation of the leg-wheel type robot at each point in the flowchart shown in FIG. 8.

FIG. 10A is an explanatory diagram schematically showing a leg-wheel type robot according to a first variation.

FIG. 10B is an explanatory diagram showing a mode in which the leg-wheel type robot shown in FIG. 10A grounds an additional pad portion.

FIG. 11A is an explanatory diagram schematically showing a leg-wheel type robot according to a second variation.

FIG. 11B is an explanatory diagram showing an example of a mode in which the leg-wheel type robot shown in FIG. 11A grounds additional pad portions.

FIG. 11C is an explanatory diagram showing another example of the mode in which the leg-wheel type robot shown in FIG. 11A grounds the additional pad portions.

FIG. 12 is a flowchart diagram illustrating a flow of control of the leg-wheel type robot according to the present variations.

### DESCRIPTION OF EMBODIMENTS

A preferable embodiment of the present disclosure will be described below in detail with reference to the attached drawings. Note that, in the present specification and the drawings, constituent elements that have substantially the same functional configuration are assigned the same reference numerals, and thus, redundant description thereof is omitted.

Note that the description will be given in the following order.

1. Application of Technique according to Present Disclosure

1.1. Configuration of Leg-type Robot

1.2. Configuration of Leg Portion

1.3. Configuration of Wheel

2. Details of Technique according to Present Disclosure

2.1. Configuration of Wheel

2.2. Configuration of Leg-type Robot

2.3. Configuration of Control Apparatus

2.4. Control Method

3. Variations

### 1. Application of Technique according to Present Disclosure

### 1.1. Configuration of Leg-type Robot

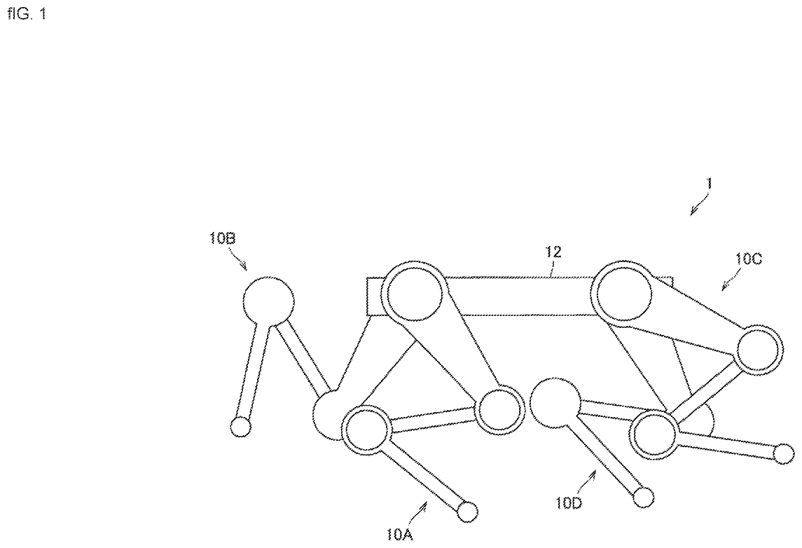

Firstly, a leg-type robot to which the technique according to the present disclosure may be applied will be described with reference to FIG. 1. FIG. 1 is a schematic diagram showing an example of a leg type robot 1 to which the technique according to the present disclosure may be applied.

As shown in FIG. 1, a leg type robot 1 to which the technology according to the present disclosure may be applied includes a body portion 12 and a plurality of leg portions 10A, 10B, 10C, and 10D (which will also be referred to collectively as leg portions 10 when not distinguished from each other).

The body portion 12 includes a control apparatus that comprehensively controls the orientation or movement of the leg type robot 1, and is supported by the plurality of leg portions 10. For example, the body portion 12 may include a control apparatus that controls the orientation of the leg portions 10. The control apparatus provided in the body portion 12 controls driving of each of the legs 10 in cooperation therewith, based on sensing information from various sensors provided on each of the leg portions 10. Control performed by the control apparatus enables the leg type robot 1 to walk using the leg portions 10.

The plurality of leg portions 10 are attached to the body portion 12, and support the body portion 12. Specifically, each of the leg portions 10 may be configured as a link structure that includes at least one joint and links that are pivotably joined to the joint. The leg portions 10A, 10B, 10C, and 10D may be link structures that are the same as each other, or may be different link structures. To enable the leg type robot 1 to walk, the number of leg portions 10 need only be at least two, and the upper limit is not specifically limited. However, to enhance the stability of the orientation or walk of the leg type robot 1, the number of leg portions 10 may be four or more.

The leg portions 10 enable the leg type robot 1 to walk as a result of the orientation of the leg portions 10 being controlled by a drive motor based on a command from the control apparatus provided in the body portion 12.

### 1.2. Configuration of Leg Portion

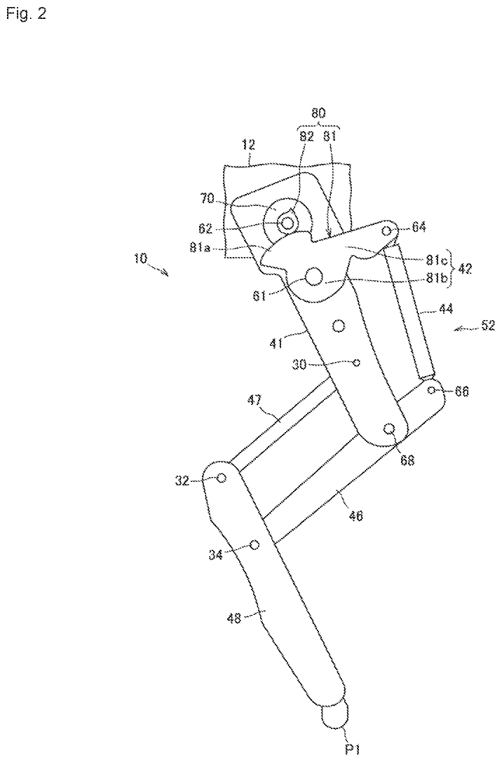

Next, a specific example of the leg portions 10 of the leg type robot 1 will be described with reference to FIG. 2. FIG. 2 is a schematic diagram showing a specific example of a structure of each leg portion 10 of the leg type robot 1.

As shown in FIG. 2, for example, each leg portion 10 includes a link mechanism 52, a motor 62, and a pair of non-circular gears 80. The link mechanism 52 is configured to be able to extend and contract in accordance with motive power output from the motor 62.

In the leg portion 10, the motive power output from the motor 62 is output to the link mechanism 52 via the pair of non-circular gears 80. The pair of non-circular gears 80 is a pair of pivotable bodies, and outputs the motive power output from the motor 62 to the link mechanism 52 at a reduction ratio corresponding to the orientation of the link mechanism 52. Specifically, the pair of non-circular gears 80 includes an input-side gear 82 and an output-side gear 81, and functions as a speed change mechanism that reduces the motive power input from the motor 62 and outputs the reduced motive power. A plurality of teeth that mesh each other are provided in an area where the input-side gear 82 and the output-side gear 81 come into contact with each other, and the output-side gear 81 may rotate in accordance with rotation of the input-side gear 82. For example, the pair of non-circular gears 80 may realize a change in the reduction ratio corresponding to the orientation of the link mechanism 52 due to the pivot angle of the output-side gear 81 being nonlinear with respect to the pivot angle of the input-side gear 82. A rotating shaft of the input-side gear 82 may be directly coupled to a rotating shaft of the motor 62, or may be coupled thereto via one or more circular gears. Note that the pair of non-circular gears 80 is also referred to simply as non-circular gears 80.

The link mechanism 52 is constituted by a plurality of links. Specifically, the link mechanism 52 includes a link 41, a link 42, which is a portion of the output-side gear 81, a link 44, a link 46, a link 47, and a link 48.

At least a portion of the link mechanism 52 constitutes a trapezoidal link mechanism. For example, the link 41, the link 42, the link 44, and the link 46 constitute a four-joint trapezoidal link mechanism in which opposing links have different link lengths.

The link 41 is provided with the aforementioned pair of non-circular gears 80 and motor 62. Specifically, the input-side gear 82 and the motor 62 are provided on one end side of the link 41, and the output-side gear 81 is provided closer to the center of the link 41 in the extending direction thereof than the input-side gear 82. The input-side gear 82 and the output-side gear 81 are joined to the link 41 via the respective rotating shafts, and are pivotably provided with respect to the link 41. However, the positions of the respective rotating shafts of the input-side gear 82 and the output-side gear 81 are relatively fixed with respect to the link 41. The motor 62 is provided to be fixed to the link 41.

The link 41 is pivotably joined, on the one end side thereof, to the body portion 12. Specifically, the link 41 is joined, on the one end side thereof, to the body portion 12 so as to be able to pivot around the rotating shaft of the input-side gear 82. The link 41 is joined, on another end side thereof, to the center of the link 46 so as to be able to pivot with a shaft portion 30 as a rotating shaft, and is joined, on the other end side thereof, to one end side of the link 47 so as to be able to pivot with a shaft portion 68 serving as a rotating shaft. Note that the shaft portion 30 is provided on the center side of the link 41 relative to the shaft portion 68.

The link 42 is configured as a portion of the aforementioned output-side gear 81, and is provided so as to be able to pivot using the motive power input from the motor 62. The output-side gear 81 is constituted by, for example, a teeth portion 81a that mesh with a teeth portion of the input-side gear 82, an attachment portion 81b that is joined to the link 41 via a shaft portion 61, and a protruding portion 81c that protrudes in a radial direction of the shaft portion 61. The protruding portion 81c is provided in a different area from the teeth portion 81a provided in a circumferential direction of the output-side gear 81, and a leading end side of the protruding portion 81c is joined to one end side of the link 44 via a shaft portion 64. That is to say, the link 42 is constituted by the attachment portion 81b and the protruding portion 81c. According to this, the link 42 can pivot integrally with the output-side gear 81, and can also pivot with respect to the link 41 with the shaft portion 61 serving as a rotating shaft. However, the link 42 can also be constituted by a plurality of members, or can be configured not as a portion of the output-side gear 81.

The link 44 is arranged opposing the link 41. Specifically, the link 44 is joined, on the one end side thereof, to another end side of the link 42 via the shaft portion 64 so as to be able to pivot with the shaft portion 64 serving as a rotating shaft. The link 44 is joined, on another end side thereof, via one end side of the link 46 via a shaft portion 66 so as to be able to pivot with the shaft portion 66 serving as a rotating shaft.

The link 46 is arranged opposing the link 42. Specifically, the link 46 is joined, on the one end side thereof, to the other end side of the link 44 via the shaft portion 66 so as to be able to pivot with the shaft portion 66 serving as a rotating shaft. The link 46 is joined, on another end side thereof, to the center of the link 48 via a shaft portion 34 so as to be able to pivot with the shaft portion 34 serving as a rotating shaft.

Furthermore, the link 47 is arranged opposing the link 46 at a different position from the link 42. The link 47 is joined, on the one end side thereof, to the center of the link 41 via the shaft portion 30 so as to be able to pivot with the shaft portion 30 serving as a rotating shaft. The link 47 is joined, on another end side thereof, to the one end side of the link 46 via a shaft portion 32 so as to be able to pivot with the shaft portion 32 serving as a rotating shaft.

The link 48 is arranged opposing the link 41 on the side opposite to the link 44. The link 48 is joined, on one end side thereof, to the other end side of the link 47 so as to be able to pivot with the shaft portion 32 serving as a rotating shaft, and is joined, on the one end side thereof, to the other end side of the link 46 so as to be able to pivot with the shaft portion 34 serving as a rotating shaft. Note that the shaft portion 34 is provided on the center side of the link 48 relative to the shaft portion 32. A ground contact portion P1 is provided on the other end side of the link 46, and the ground contact portion P1 comes into contact with the ground or the like.

Thus, a parallel link mechanism is constituted by the link 41, the link 46, the link 47, and the link 48. In the parallel link mechanism, the link lengths of the link 41 and the link 48 that oppose each other substantially coincide with each other, and the link lengths of the link 46 and the link 47 that oppose each other substantially coincide with each other. Specifically, the distance between the shaft portion 30 and the shaft 68 substantially coincides with the distance between the shaft portion 32 and the shaft portion 34, and the distance between the shaft portion 30 and the shaft portion 32 substantially coincides with the distance between the shaft portion 68 and the shaft portion 34.

With the above-described leg portion 10, it is possible to extend and contract the link mechanism 52 and control the orientation of the leg portion 10 by transmitting torque output from the motor 62 to the link mechanism 52. Note that the orientation of the link mechanism 52 is an orientation in which imparted moment is kept balanced at each of the links.

### 1.3. Configuration of Wheel

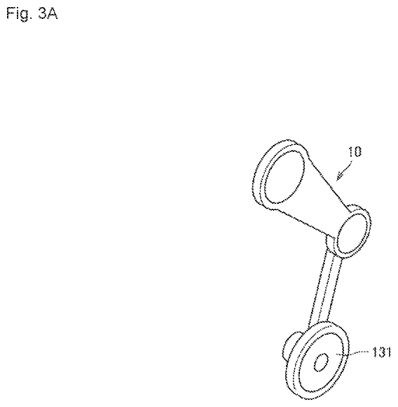

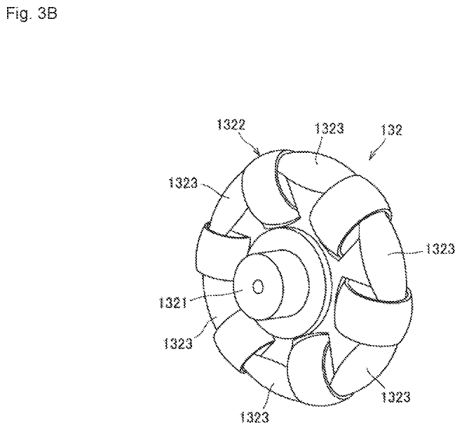

Subsequently a wheel mechanism provided on each leg portion 10 of the leg type robot 1 will be described with reference to FIGS. 3A and 3B. The leg type robot 1 with the wheel mechanism provided on each leg portion 10 will also be referred to as a leg-wheel type robot. FIG. 3A is a perspective view schematically showing the leg portion 10 on which the wheel mechanism is provided.

As shown in FIG. 3A, in the leg-wheel type robot, a wheel 131 is provided in an area corresponding to the ground contact portion P1 of the leg portion 10. Specifically, the wheel 131 is provided at one end of the link 48, which is a terminal of the leg portion 10. The link 48 is coupled to a shaft portion of the wheel 131 via a bearing or the like such that the wheel 131 can rotate.

The leg-wheel type robot with the wheel 131 provided on each leg portion 10 can travel fast using the wheel 131 on a flat paved surface or the like, and can walk through reciprocating motion of the leg portion 10 on a traveling surface that is uneven, for example. Accordingly, the leg-wheel type robot provided with the wheel 131 can increase the moving speed or efficiency while maintaining high terrain adaptability.

FIG. 3B is a perspective view schematically showing an example of the wheel mechanism provided on each leg portion 10. The wheel mechanism provided on each leg portion 10 may be, for example, an omni wheel 132 such as that shown in FIG. 3B, in place of the typical wheel 131 such as that shown in FIG. 3A.

As shown in FIG. 3B, the omni wheel 132 is, for example, a wheel in which a plurality of small rollers 1323 capable of rotating in the width direction of a wheel body 1322 are provided in a circumferential portion of the wheel body 1322 that surrounds a shaft portion 1321. Specifically, the small rollers 1323 have a rotary body shape that is a barrel shape or a spindle shape, and a plurality of small rollers 1323 are separately arranged such that their rotating shafts are oriented in the circumferential direction of the wheel body 1322.

The wheel body 1322 that includes the small rollers 1323 is provided in a circular shape as a whole. Accordingly, the omni wheel 132 can cause the leg-wheel type robot to travel in a direction perpendicular to the rotating shaft of the wheel body 1322 by rotating the wheel body 1322 with the shaft portion 1321 serving as a rotating shaft. Also, since the small rollers 1323 can rotate in the width direction of the wheel body 1322, the omni wheel 132 can cause the leg-wheel type robot to travel in the width direction of the wheel body 1322 by rotating grounded small rollers 1323. That is to say, the omni wheel 132 enables the leg-wheel type robot to move in multiple directions by combining rotations of the small rollers 1323 and the wheel body 1322 without changing the orientation of the wheel body 1322.

Here, if a braking mechanism such as a disc brake or a drum brake is provided for the wheel mechanism provided on each leg portion 10 of the leg-wheel type robot, the mass and inertia of the leg portion 10 significantly increase. Therefore, providing a disc brake, a drum brake, or the like for the wheel mechanism of each leg portion 10 increases driving torque of the leg portion 10 during walking movement.

Also, if the wheel mechanism provided on each leg portion 10 is the omni wheel 132, a disc brake, a drum brake, or the like can apply braking to the rotation of the entire wheel body 1322, but it is difficult to apply braking to the rotation of each of the small rollers 1323. For this reason, with the omni wheel 132, the small rollers 1323 rotate even if braking is applied using a disc brake, a drum brake, or the like, and it is therefore difficult to stop the leg-wheel type robot.

The technique according to the present disclosure was conceived in view of the foregoing circumstances. The technique according to the present disclosure makes it possible to apply a braking force to the leg-wheel type robot using a simpler and lighter mechanism. In the following, this technique according to the present disclosure will be described in detail. Note that, in the following, “to be grounded” means that a certain member comes into contact with the ground.

### 2. Details of Technique according to Present Disclosure

### 2.1. Configuration of Wheel

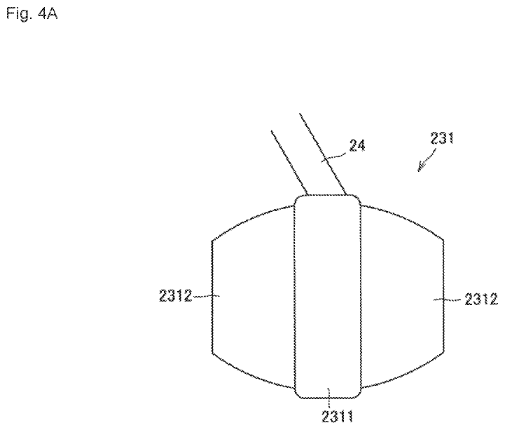

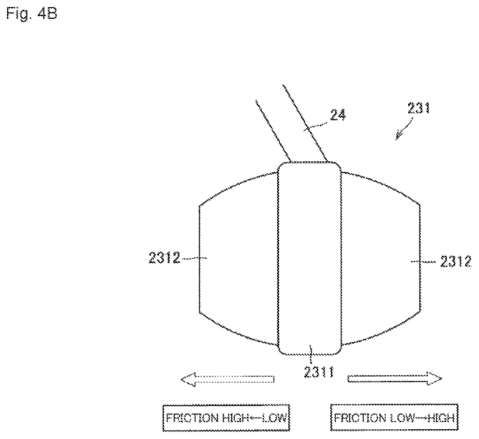

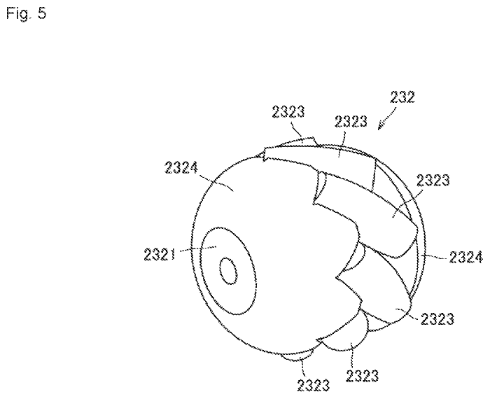

Firstly, the wheel mechanism used in the technique according to the present disclosure will be described with reference to FIGS. 4A to 5. FIG. 4A is an explanatory diagram schematically showing a wheel used in the technique according to the present disclosure, and FIG. 4B is an explanatory diagram schematically showing a variation of the wheel shown in FIG. 4A. FIG. 5 is a perspective view schematically showing another example of the wheel used in the technique according to the present disclosure.

As shown in FIG. 4A, a wheel 231 used in the technique according to the present disclosure includes a wheel body 2311 that is provided at one end of a link 24, which is a terminal of each leg portion, and a pad portion 2312 that is provided on at least one side face of the wheel body 2311 and has a higher frictional resistance with respect to the ground surface than that of the wheel body 2311.

The wheel body 2311 has a substantially disc shape. Although not shown in detail in FIG. 4A, the wheel body 2311 is connected, via a bearing or the like, to the link 24 that is the terminal of the leg portion so as to be able to rotate with the center of the substantially disk shape serving as the rotation axis.

The pad portion 2312 is made of a material with a higher frictional resistance with respect to the ground surface than that of the wheel body 2311, and is provided on one of or both the two side faces of the wheel body 2311. If the frictional resistance at the time of being grounded is high, the pad portion 2312 may be provided fixed to the wheel body 2311 so as to rotate together with the wheel body 2311, or may be provided separately from the wheel body 2311 so as not to rotate.

The technique according to the present disclosure is for controlling a braking force that acts on the leg-wheel type robot by controlling the orientation of each leg portion of the leg-wheel type robot in a pitch axis direction and performing control to set either the wheel body 2311 or the pad portion 2312 as a ground contact area between the leg portion and the ground. Specifically, the technique according to the present disclosure is for increasing the frictional resistance between the leg portions and the ground surface and applying a braking force to the leg-wheel type robot by tilting each leg portion of the leg-wheel type robot in the pitch axis direction and bringing the pad portion 2312 into contact with the ground surface.

For this reason, the pad portion 2312 may be made of a material that has a higher frictional resistance with respect to the ground surface than that of the wheel body 2311. For example, the pad portion 2312 may be made of the same material as a typical material used in a brake pad.

Also, the pad portion 2312 may be provided in a surface shape with which the frictional resistance with respect to the ground surface is higher than that of the wheel body 2311. In that case, the pad portion 2312 may be made of the same material as a typical material used in the wheel body 2311.

If the pad portion 2312 is provided separately from the wheel body 2311 so as not to rotate, the pad portion 2312 has a higher rolling resistance with respect to the ground surface than that of the wheel body 2311. With this configuration as well, the frictional resistance of the pad portion 2312 with respect to the ground surface can be made higher than that of the wheel body 2311.

The shape of the pad portion 2312 may have any shape that has a thickness in the pitch axis direction of the leg-wheel type robot, but for example, the shape described below may also be employed.

The shape of the pad portion 2312 may be a shape whose cross-sectional shape in any section perpendicular to a roll axis of the leg-wheel type robot is a substantially semi-circular shape or a substantially fan shape. More specifically, the shape of the pad portion 2312 may be a hemispherical shape or a semi-elliptic shape. The technique according to the present disclosure controls which of the wheel body 2311 and the pad portion 2312 is to be grounded, using the tilt of the wheel 231. For this reason, the shape of the pad portion 2312 may be a shape with which it can be readily grounded by the tilt of the wheel 231.

For example, if the shape of the pad portion 2312 is a shape whose cross-sectional shape in a section perpendicular to the roll axis of the leg-wheel type robot is a substantially semi-circular shape or a substantially fan shape, the shape of the pad portion 2312 is a shape with a curved face that is substantially continuous from the wheel body 2311. According to this, the wheel 231 can smoothly switch the ground contact area that comes into contact with the ground between the wheel body 2311 and the pad portion 2312 in accordance with the tilt of the wheel 231.

Also, the shape of the pad portion 2312 may be a shape with a cross-sectional shape in which a portion of an arc of the aforementioned substantially semi-circular shape or substantially fan shape is replace with a straight line perpendicular to the ground surface. Specifically, the shape of the pad portion may be a shape obtained by cutting out a portion of a curved face of the hemispherical shape or the semi-elliptic shape along a plane perpendicular to the roll axis of the leg-wheel type robot. More specifically, the shape of the pad portion 2312 may be a bowl-like shape, as shown in FIG. 4A. According to this, when stopping, the leg-wheel type robot can stably stop even if the ground surface is a slope or the like, by grounding a flat face provided in a portion of the curved face of the hemispherical shape or the semi-elliptic shape of the pad portion 2312.

Also, in the wheel 231 used in the technique according to the present disclosure, the pad portion 2312 may be provided such that the frictional resistance changes in accordance with the distance from wheel body 2311. Specifically, as shown in FIG. 4B, the pad portion 2312 may be provided such that the frictional resistance is higher on a side further away from the wheel body 2311. According to this configuration, the pad portion 2312 can control the magnitude of the braking force to be applied to the leg portion by controlling the face that comes into contact with the ground.

In that case, the leg-wheel type robot can ground the pad portion 2312 and apply a braking force to the leg portion by tilting the leg portion 10 from a state where the wheel body 2311 is grounded. Furthermore, the leg-wheel type robot can apply a larger braking force to the leg portion by increasing the tilt of the leg portion and grounding an outer side of the pad portion 2312.

Particularly, with the wheel 231 shown in FIG. 5, the ground contact area can be gradually changed from the wheel body 2311 with a lower frictional resistance to the pad portion 2312 with a higher frictional resistance by tilting the wheel 231. Also, since the wheel 231 shown in FIG. 5 has the pad portion 2312 with a bowl-like shape, after the leg-wheel type robot has stopped, the leg-wheel type robot can be stably stopped by grounding the flat face provided in a portion of the curved face of the pad portion 2312.

Note that the pad portion 2312 may have different frictional resistances in accordance with the distance from the wheel body 2311 by changing the formation material in accordance with the distance from the wheel body 2311. Alternatively, the pad portion 2312 may have different frictional resistances in accordance with the distance from the wheel body 2311 by changing the surface shape in accordance with the distance from the wheel body 2311.

Furthermore, in the wheel 231 used in the technique according to the present disclosure, the pad portion 2312 may be provided so as to have different characteristics in accordance with the distance from the wheel body 2311. For example, the material and the surface shape of the pad portion 2312 may be changed so as to have characteristics of a studless tire, a snow tire, or a spike tire for snow roads and ice roads, depending on the distance from the wheel body 2311. According to this configuration, the leg-wheel type robot can change the ground contact face of the wheel 231 into a state suitable for different traveling surfaces by changing the orientation of the leg portion and switching the ground contact area from the wheel body 2311 to the pad portion 2312.

Here, the wheel mechanism used in the technique according to the present disclosure may be an omni wheel. Specifically, as shown in FIG. 5, an omni wheel 232 may include a shaft portion 2321 that serves as an rotating shaft of the omni wheel 232, a plurality of small rollers 2323 that are provided to form a band shape in the circumferential direction of the shaft portion 2321, and a pad portion 2314 that is provided on at least one side face of the plurality of small rollers 2323 provided to form a band shape and has a higher frictional resistance with respect to the ground surface than that of the small rollers 2323.

However, needless to say, the omni wheel 132 with a structure such as that shown in FIG. 3B may be used as the wheel mechanism used in the technique according to the present disclosure. In that case, the omni wheel 132 can fulfil the same function as that of the omni wheel 232 shown in FIG. 5 by being provided with the pad portion 2312 shown in FIG. 5 on a side face of the shaft portion 1321.

The shaft portion 2321 is provided to pass through the omni wheel 232 in the width direction, and functions as the rotating shaft that rotates the entire omni wheel 232. The shaft portion 2321 may be, for example, joined to a link that is a terminal of the leg portion (not shown) in the width direction of the omni wheel 232.

The small rollers 2323 are rotatably provided in a rotary body shape that is a barrel shape or a spindle shape. A plurality of small rollers 2323 may be provided to form a band shape in the circumferential direction of the shaft portion 2321.

Specifically, each of the small rollers 2323 may have a barrel shape or a spindle shape extending in a direction diagonal with respect to the pitch axis direction of the leg-wheel type robot, and a plurality of small rollers 2323 may be provided to form a band shape in the circumferential direction of the shaft portion 2321. The small rollers 2323 are provided so as to be able to rotate with a rotation axis in a direction diagonal with respect to the pitch axis direction of the leg-wheel type robot. The small rollers 2323 can enable, by rotating, the leg-wheel type robot to travel in the pitch axis direction and the roll axis direction of the leg-wheel type robot.

For example, in the leg-wheel type robot that includes the omni wheels 232, by rotating each of the omni wheels 232 of the leg portions arranged in the pitch axis direction of the leg-wheel type robot, forces traveling in the pitch axis direction can be cancelled out and the leg-wheel type robot can travel in the roll axis direction. Also, in the leg-wheel type robot, by rotating each of the omni wheels 232 of the leg portions that are arranged in the roll axis direction of the leg-wheel type robot, forces traveling in the roll axis direction can be cancelled out and the leg-wheel type robot can travel in the pitch axis direction.

The pad portions 2324 are provided on the two side faces of the plurality of small rollers 2323 that are provided to form a band shape, and is made of a material with a higher frictional resistance with respect to the ground surface than that of the small rollers 2323. Specifically, the pad portions 2324 are provided on the two side faces of the plurality of small rollers 2323 so as to sandwich the two ends of the small rollers 2323 in a direction diagonal with respect to the pitch axis direction.

Note that the pad portions 2324 may be made of the same material as that of the pad portion 2312 described in FIG. 4A. Also, the shape of the pad portions 2324 may be the same shape as that of the pad portion 2312 described in FIG. 4A. Furthermore, the frictional resistance of the pad portions 2324 may change in accordance with the distance from the small rollers 2323.

The wheel mechanism used in the technique according to the present disclosure has been described above in detail. In the technique according to the present disclosure, a braking force that acts on the leg-wheel type robot can be controlled by controlling the orientation in the pitch axis direction of each leg portion of the leg-wheel type robot and switching the ground contact area between the leg portion 10 and the ground from the wheel body 2311 to the pad portion 2312. That is to say, in the technique according to the present disclosure, a braking force that derives from the frictional resistance of the pad portion 2312 is applied to the leg portion by grounding the pad portion 2312, which has a higher frictional resistance with respect to the ground surface than that of the wheel body 2311.

According to this configuration, the leg-wheel type robot can apply a braking force to the leg portion by using the pad portion 2312 provided on a side face of the wheel body 2311 and changing the orientation of the leg portion, without using a large braking mechanism equipped with an actuator such as a disc brake or a drum brake. Accordingly, the leg-wheel type robot can apply braking to the leg portion using a simpler and lighter configuration.

If the wheel mechanism provided to the leg portion is the omni wheel 232, the leg-wheel type robot can ground the pad portions 2324 while not grounding the small rollers 2323 by changing the orientation of the leg portion. According to this, the leg-wheel type robot can stop more reliably.

For example, with the omni wheel 132, even if the rotation of the entire omni wheel 132 is stopped, the ground contact position of the leg portion may shift as a result of the small rollers 1323 on the ground surface rotating due to an external force or the like. With the technique according to the present disclosure, the frictional resistance with respect to the ground surface can be increased by tilting the orientation of the leg portion and changing the face that comes into contact with the ground from the small rollers 2323 to the pad portions 2324. According to this, the leg-wheel type robot can suppress the position at which the leg portion is installed from shifting due to an external force or the like, without applying braking to each of the small rollers 2323.

### 2.2. Configuration of Leg-type Robot

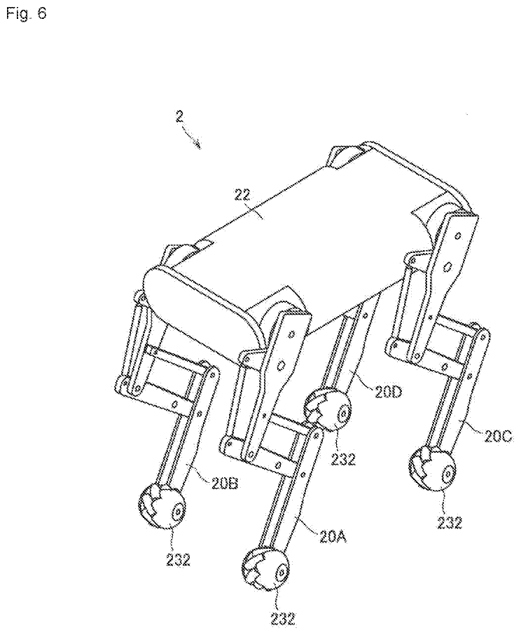

Subsequently, the leg-wheel type robot used in the technique according to the present disclosure will be described with reference to FIG. 6. FIG. 6 is a perspective view schematically showing the leg-wheel type robot used in the technique according to the present disclosure.

As shown in FIG. 6, a leg-wheel type robot 2 used in the technique according to the present disclosure may include, for example, a body portion 22 and leg portions 20A, 20B, 20C, and 20D (which will also be referred to collectively as leg portions 20 when not distinguished from each other) each of which has the omni wheel 232 shown in FIG. 5 at a ground contact portion thereof. However, needless to say, each leg portion 20 of the leg-wheel type robot 2 may have the wheel 231 shown in FIG. 4A or the like, in place of the omni wheel 232.

The body portion 22 includes a control apparatus that controls the orientation or movement of the leg-wheel type robot 2, and is supported by the plurality of leg portions 20. For example, the body portion 22 may include a control apparatus that controls the orientation of the leg portions 20.

A plurality of leg portions 20 are attached to the body portion 22, and supports the body portion 22. Specifically, each of the leg portions 20 is configured as a link structure that includes at least one joint and links that are pivotably joined to the joint, and the omni wheel 232 is provided at a ground contact portion of a link at a terminal of the link structure of the leg portion 20.

The omni wheels 232 of each leg portion 20 is provided so as to apply a driving force in a direction diagonal with respect to the pitch axis direction of the leg-wheel type robot 2. In addition, the omni wheels 232 of leg portions 20 that are adjacent in the pitch axis direction and the roll axis direction of the leg-wheel type robot 2 are provided so as to apply driving forces in alternate directions. Thus, the leg-wheel type robot 2 can move in multiple directions without changing the orientation of the leg-wheel type robot 2 itself by compositing driving forces from the omni wheels 232 of the leg portions 20.

### 2.3. Configuration of Control Apparatus

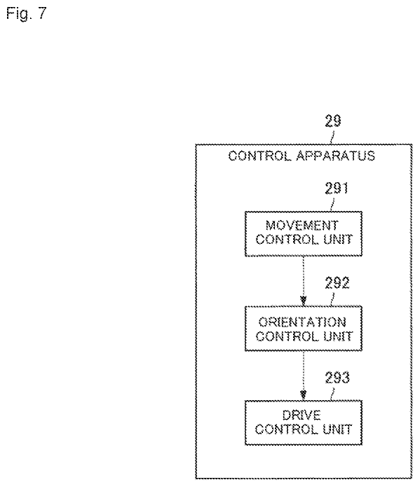

Next, a functional configuration of the control apparatus that controls the orientation of the leg-wheel type robot 2 will be described with reference to FIG. 7. FIG. 7 is a block diagram illustrating the functional configuration of a control apparatus 29.

As shown in FIG. 7, the control apparatus 29 includes a movement control unit 291, an orientation control unit 292, and a drive control unit 293.

The movement control unit 291 controls the moving speed of the leg-wheel type robot 2. Specifically, the movement control unit 291 controls the moving speed of the leg-wheel type robot 2 based on an autonomously determined movement plan, or based on an instruction given from the outside. For example, the movement control unit 291 may acquire the current moving speed of the leg-wheel type robot 2 that is measured by a sensor or the like, and give an instruction to accelerate or decelerate the leg-wheel type robot 2 such that the current moving speed approaches a target moving speed.

The orientation control unit 292 controls the orientation of the leg-wheel type robot 2. Specifically, if an instruction to decelerate the leg-wheel type robot 2 is given from the movement control unit 291, the orientation control unit 292 decelerates the leg-wheel type robot 2 by controlling the orientation of the leg-wheel type robot 2 and applying braking to each of the leg portions 20.

For example, the orientation control unit 292 may apply braking to each of the leg portions 20 by tilting each of the leg portions 20 in the pitch axis direction of the leg-wheel type robot 2 and grounding the pad portion 2312. When decelerating the leg-wheel type robot 2, the orientation control unit 292 may apply braking to all of the leg portions 20, or may apply braking to some of the leg portions 20. However, if the orientation control unit 292 controls the orientation of all of the leg portions 20 to decelerate the leg-wheel type robot 2, the orientation control unit 292 can readily stabilize the orientation of the leg-wheel type robot 2 during the deceleration.

The drive control unit 293 controls driving of each joint of the leg portions 20. Specifically, the drive control unit 293 controls driving of the joints provided in each of the leg portions 20 such that the orientation instructed by the orientation control unit 292 is achieved. For example, the drive control unit 293 may control the orientation of each of the leg portions 20 in an orientation instructed by the orientation control unit 292 by controlling the output of an actuator for driving the joints provided in each of the leg portions 20.

The above-described control apparatus 29 can be realized by, for example, cooperation between hardware such as a CPU (Central Processing Unit) or an MPU (Micro Processing Unit), a RAM (Random Access Memory), and a ROM (Read Only Memory), and software for controlling operation of each component.

The CPU or the MPU functions as a processor and performs information processing and information operation in general in the control apparatus 29 in accordance with various programs stored in the ROM or the like. The ROM stores programs used by the CPU and operation parameters, and the RAM temporarily stores programs used in execution of the CPU and parameters or the like that change as appropriate during the execution. The CPU, ROM, and RAM are connected to each other by an internal bus, a bridge, or the like, for example.

Note that it is also possible to create a computer program for causing the hardware such as the CPU, the ROM, and the RAM contained in the control apparatus 29 to perform functions equal to those of the above-described components of the control apparatus. It is also possible to provide a storage medium that stores this computer program.

### 2.4. Control Method

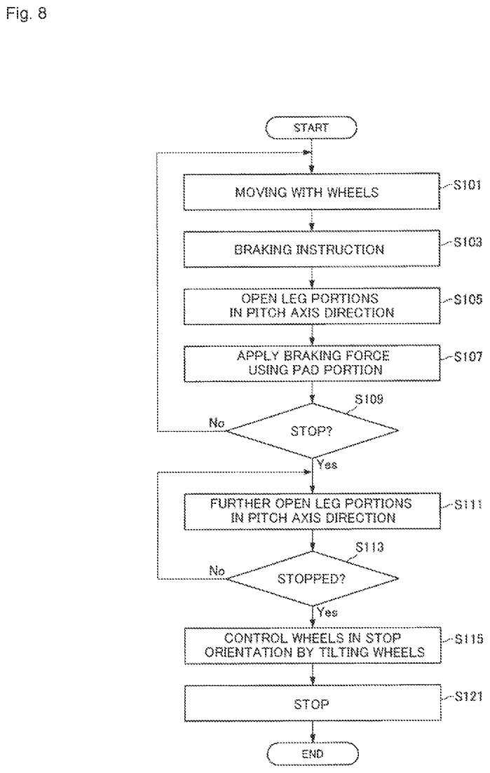

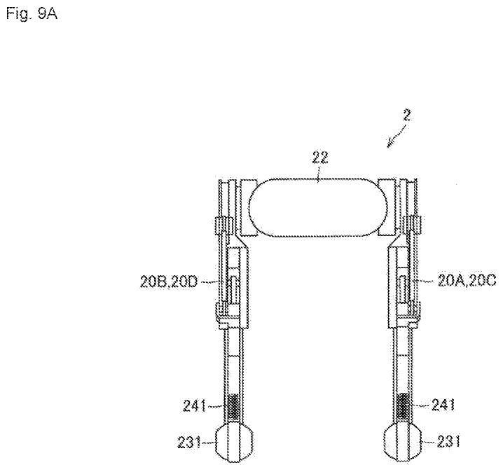

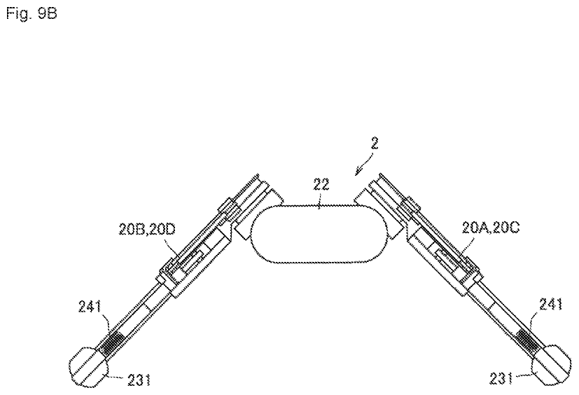

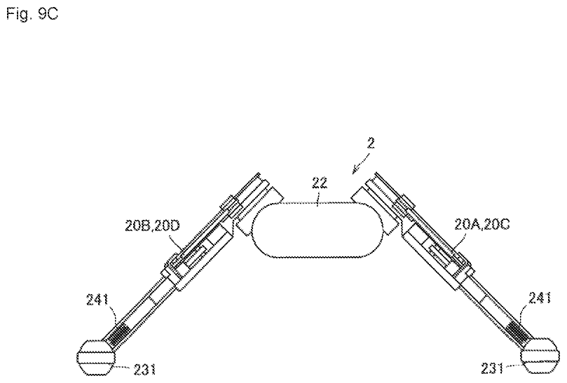

Subsequently, a flow of control of the leg-wheel type robot 2 performed by the above-described control apparatus 29 will be described with reference to FIGS. 8 to 9C. FIG. 8 is a flowchart diagram illustrating a flow of control of the leg-wheel type robot 2 performed by the control apparatus 29. FIGS. 9A to 9C are schematic explanatory diagrams showing orientations of the leg-wheel type robot 2 at each point in the flowchart shown in FIG. 8.

Note that in the leg-wheel type robot 2 shown in FIGS. 9A to 9C, the leg portions 20 and the wheels 231 are connected to each other via elastic members 241, such as helical springs. In that case, the leg portions 20 and the wheels 231 can swing with respect to each other. Accordingly, the tilt of the wheels 231 can be adjusted with respect to a change in the orientation of the leg portions 20, in accordance with the unevenness or the like of the ground surface. The elastic members 241 can also function as shock absorbers between the leg portions 20 and the wheels 231. According to this, the elastic members 241 can mitigate vibration or impact transmitted from the ground surface to the body portion 22.

As shown in FIG. 8, first, it is assumed that the leg-wheel type robot 2 is moving with the wheels 231 (S101). At this time, the orientation of the leg-wheel type robot 2 is such that each of the leg portions 20 is extended vertically from the body portion 22, as shown in FIG. 9A. In such a case, since each wheel 231 is grounded at the wheel body 2311, the braking force from the ground surface hardly acts on the leg portion 20.

Here, if a braking instruction to decelerate the leg-wheel type robot 2 is output from the movement control unit 291 (S103), the orientation control unit 292 opens each of the leg portions 20 in the pitch axis direction of the leg-wheel type robot 2 (S105).

As a result of the pad portion 2312 thus being grounded, a braking force is applied to the leg-wheel type robot 2 by the pad portion 2312 (S107), and thus the leg-wheel type robot 2 decelerates. At this time, the orientation of the leg-wheel type robot 2 is such that each of the leg portions 20 is extended from the body portion 22 such that terminal side portions of the leg portions 20 are spread apart from each other, as shown in FIG. 9B. As a result, each wheel 231 is grounded at the pad portion 2312 on a side face of the wheel body 2311, and thus a braking force acts on the leg portion 20 from the ground surface.

Thereafter, the movement control unit 291 determines whether or not to stop the leg-wheel type robot 2 (S109). If the leg-wheel type robot 2 is not to be stopped (S109/No), the flow returns to step S101, and it is determined again at the movement control unit 291 whether to accelerate or decelerate the leg-wheel type robot 2. On the other hand, if the leg-wheel type robot 2 is to be stopped (S109/Yes), the orientation control unit 292 further opens each of the leg portions 20 in the pitch axis direction of the leg-wheel type robot 2 (S111). Due to the pad portion 2312 being configured such that the frictional resistance increases in accordance with the distance from the wheel body 2311, the braking force that acts on the leg portion 20 from the ground surface can be further increased by further opening each of the leg portions 20 and grounding the outer pad portion 2312.

Subsequently, the movement control unit 291 determines whether or not the leg-wheel type robot 2 has stopped (S113). If the leg-wheel type robot 2 has not stopped (S113/No), the flow returns to step S111, and each of the leg portions 20 is further opened by the orientation control unit 292 (S113). On the other hand, if the leg-wheel type robot 2 has stopped (S113/Yes), the orientation control unit 292 grounds the flat face provided on the side face of the pad portion 2312 by tilting each wheel 231, and thus controls the wheel 231 in a stop orientation (S115). Thus, the leg-wheel type robot 2 stops (S121). At this time, the orientation of the leg-wheel type robot 2 is such that each of the leg portions 20 is extended from the body portion 22 such that the terminal side portions of the leg portions 20 are spread apart from each other, as shown in FIG. 9C. Also, the wheel 231 connected to the leg portion 20 via the elastic member 241 swings with respect to the leg portion 20, and is thus grounded in the flat face provided in a portion of the curved face of the pad portion 2312. Thus, the leg-wheel type robot 2 can readily maintain the stopped state even when an external force is applied.

### 3. Variations

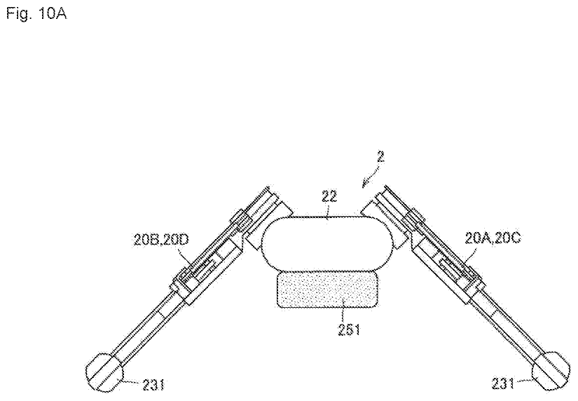

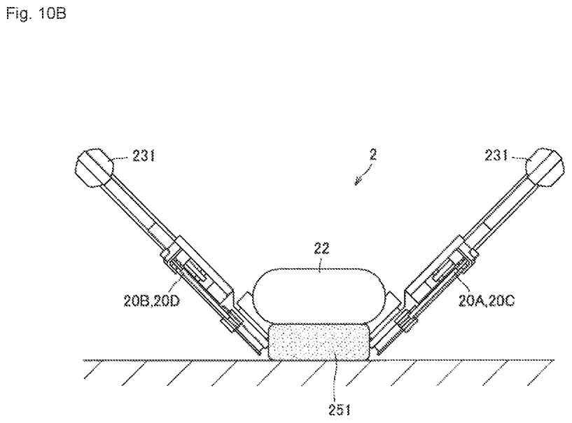

Furthermore, variations of the technique according to the present disclosure will be described with reference to FIGS. 10A to 12. In the present variations, an additional pad portion is further provided to either the body portion 22 or each leg portion 20 of the leg-wheel type robot 2, and a larger braking force is obtained by grounding the additional pad portion when the leg-wheel type robot 2 is to be suddenly decelerated, such as when performing a sudden stop. In the following, configurations of the present variations will be described separately for the parts to which the additional pad portion is provided.

Firstly, a first variation in which the additional pad portion is provided to the body portion 22 will be described with reference to FIGS. 10A and 10B. FIG. 10A is an explanatory diagram schematically showing the leg-wheel type robot 2 according to the first variation. FIG. 10B is an explanatory diagram showing a mode in which the leg-wheel type robot 2 shown in FIG. 10A grounds the additional pad portion.

As shown in FIG. 10A, for example, an additional pad portion 251 may be provided on a face of the body portion 22 of the leg-wheel type robot 2 that opposes the ground. Specifically, the additional pad portion 251 may be provided on a belly face side of the body portion 22 of the leg-wheel type robot 2.

For example, the additional pad portion 251 is provided such that the frictional resistance is higher than that of the wheel body 2311 by being made of the same material and provided in the same surface shape as those of the pad portion 2312 of the above-described wheel 231. Also, since the additional pad portion 251 is provided on the body portion 22 of the leg-wheel type robot 2, the additional pad portion 251 is provided with a larger area than that of the pad portion 2312 of the wheel 231. For this reason, the ground contact area of the additional pad portion 251 when coming into contact with the ground can be made larger than that of the pad portion 2312, and therefore a larger braking force can be obtained when grounded, and the leg-wheel type robot 2 can be suddenly stopped.

For example, with the leg-wheel type robot 2 shown in FIG. 10A, the additional pad portion 251 provided on the belly face side of the body portion 22 can be brought into contact with ground 50 by spreading out the leg portions 20 on the back face side of the body portion 22, as shown in FIG. 10B. In that case, to prevent damage to the leg-wheel type robot 2 due to the contact with the ground 50, the additional pad portion 251 may be provided over the entire surface on the belly face side of the body portion 22.

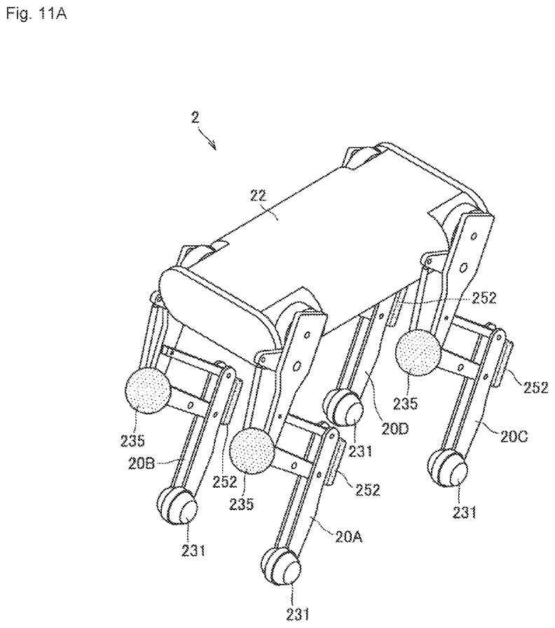

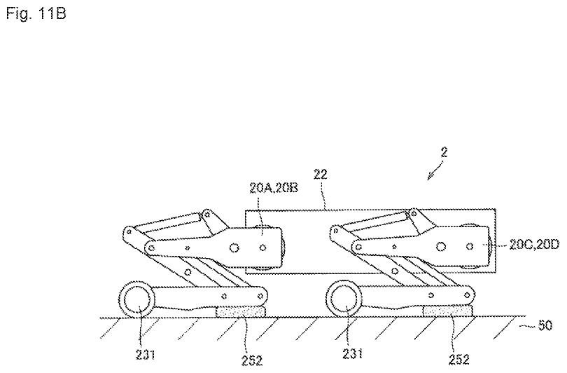

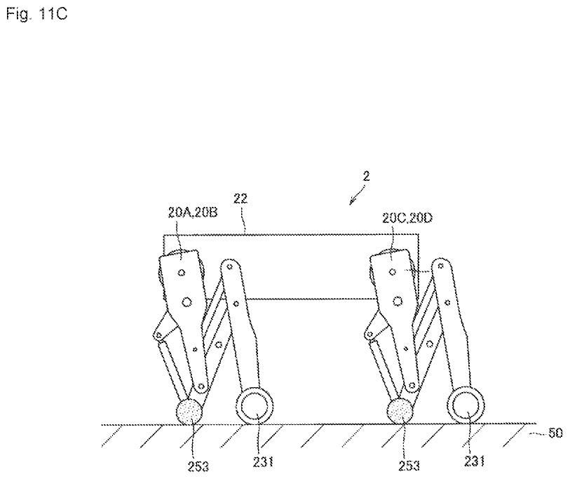

Subsequently, the second variation in which additional pad portions 252 and 253 are provided on each leg portion 20 will be described with reference to FIGS. 11A to 11C. FIG. 11A is an explanatory diagram schematically showing the leg-wheel type robot 2 according to the second variation. FIG. 11B is an explanatory diagram showing an example of a mode in which the leg-wheel type robot 2 shown in FIG. 11A grounds the additional pad portions, and FIG. 11C is an explanatory diagram showing another example of the mode in which the leg-wheel type robot 2 shown in FIG. 11A grounds the additional pad portions.

As shown in FIG. 11A, for example, the additional pad portions 252 and 253 may be provided on each leg portion 20 of the leg-wheel type robot 2. Specifically, the additional pad portion 252 and 253 may be provided on any of the links or joints of the link mechanism that constitutes each leg portion 20. However, the additional pad portions 252 and 253 are provided on links or joints that can be grounded by extending or contracting the link mechanism that constitutes each leg portion 20, of the links and the joints of the leg portion 20. Note that the additional pad portions 252 and 253 may be provided in a plurality of areas of each leg portion 20, or may be provided in one area thereof.

The additional pad portions 252 and 253 are provided such that the frictional resistance is higher than that of the wheel body 2311 by being made of the same material and provided in the same surface shape as those of the pad portion 2312 of the above-described wheel 231. Also, since a plurality of additional pad portions 252 and 253 can be provided on each of the leg portions 20, a larger braking force can be obtained when grounded than with the pad portion 2312 of the wheel 231. Accordingly, the additional pad portions 252 and 253 can suddenly stop the leg-wheel type robot 2.

For example, with the leg-wheel type robot 2 shown in FIG. 11A, the additional pad portions 252 or 253 provided on one of the links of each leg portion 20 can be brought into contact with the ground 50 by contracting the link mechanism that constitutes the leg portion 20, as shown in FIG. 11B or 11C. In that case, the leg-wheel type robot 2 brings the leg portions 20, rather than the body portion 22 that includes the control apparatus 29 and other components, into contact with the ground 50 when performing a sudden stop, and it is therefore possible to reduce the likelihood that the control apparatus 29 and other components are damaged.

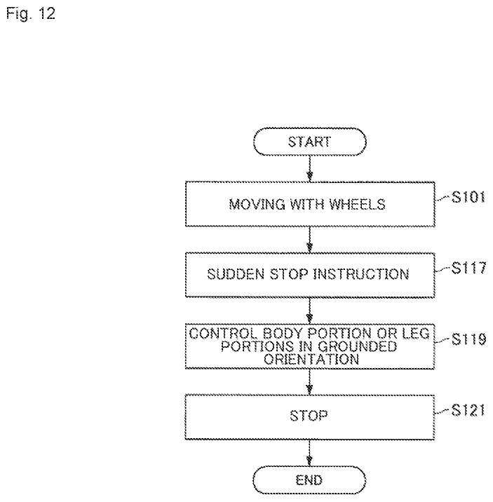

A flow of control of the leg-wheel type robot 2 according to the present variations will be described with reference to FIG. 12. FIG. 12 is a flowchart diagram illustrating a flow of control of the leg-wheel type robot 2 according to the present variations.

As shown in FIG. 12, first, it is assumed that the leg-wheel type robot 2 is moving with the wheel 231 (S101). Here, if a sudden stop instruction to suddenly stop the leg-wheel type robot 2 is output from the movement control unit 291 (S117), the orientation control unit 292 controls the orientation of the body portion 22 or the leg portions 20 of the leg-wheel type robot 2 in a grounded orientation (S119). As a result of any of the additional pad portions 251, 252, and 253 provided on the body portion 22 or the leg portions 20 thus being grounded, a larger braking force is applied to the leg-wheel type robot 2 by the additional pad portion 251, 252, or 253, and thus the leg-wheel type robot 2 suddenly decelerates and then stops (S121).

According to the present variations, the leg-wheel type robot 2 can be suddenly stopped by using the additional pad portions 251, 252, 253, or the like, without using a large braking mechanism equipped with an actuator such as a disc brake or a drum brake. Accordingly, the leg-wheel type robot can apply braking to the leg portions 10 using a simpler and lighter configuration.

Although a preferable embodiment of the present disclosure has been described in detail with reference to the attached drawings, the technical scope of the present disclosure is not limited to such an example. It is apparent that a person having common knowledge in the technical field of the present disclosure may conceive various changes or variations within the scope of the technical idea described in the claims, and it is understood that such changes and variations also naturally pertain to the technical scope of the present disclosure.

For example, in the above embodiment, the leg-wheel type robot 2 applies a braking force to each leg portion 20 by bringing the pad portion 2312 or the like into contact with the ground, but the present technique is not limited to such an example. For example, the leg-wheel type robot 2 may apply a braking force to each leg portion 20 by bringing the pad portion 2312 or the like into contact with a wall, a ceiling, or the like, rather than the ground.

The effects described in the present specification are merely descriptive or exemplary, and are not limited. That is to say, the technique according to the present disclosure may have other effects that are apparent to those skilled in the art from the description of the present specification, in addition to or in place of the above-described effects.

Note that the following configurations also pertain to the technical scope of the present disclosure.

(1)

A control apparatus including

a control unit that controls an orientation of a mobile body equipped with a plurality of leg portions each including at least one joint,

each of the leg portions having:

a wheel body that is provided at a leading end of the leg portion and grounds the leg portion; and

a pad portion that is provided on at least one side face of the wheel body and has a higher frictional resistance with respect to a ground surface than that of the wheel body,

wherein the control unit controls a braking force that acts on the mobile body from the ground surface by controlling orientations of the leg portions in a pitch axis direction of the mobile body.

(2)

The control apparatus according to the item (1) above,

wherein a cross-sectional shape of the pad portion along any section perpendicular to a roll axis of the mobile body is a substantially semi-circular shape or a substantially fan shape.

(3)

The control apparatus according to the item (2) above,

wherein the cross-sectional shape of the pad portion along the section is a shape in which a portion of an arc of the substantially semi-circular shape or the substantially fan shape is replaced with a straight line perpendicular to the ground surface.

(4)

The control apparatus according to the item (3) above,

wherein a shape of the pad portion is a shape obtained by cutting out a portion of a curved face of a hemisphere along a plane perpendicular to the roll axis of the mobile body.

(5)

The control apparatus according to any one of the items (1) to (4) above, wherein a frictional resistance on a surface of the pad portion varies in accordance with a distance from the wheel body.

(6)

The control apparatus according to the item (5) above,

wherein the frictional resistance on the surface of the pad portion is larger on a side further away from the wheel body.

(7)

The control apparatus according to the item (5) or (6) above,

wherein a surface shape of the pad portion varies in accordance with the distance from the wheel body.

(8)

The control apparatus according to any one of the items (1) to (7) above,

wherein the control unit controls the braking force that acts on the mobile body from the ground surface by swinging the leg portions in the pitch axis direction of the mobile body and bringing the pad portion into contact with the ground surface.

(9)

The control apparatus according to any one of the items (1) to (8) above, further including

an additional pad portion on a body portion or each of the leg portions of the mobile body,

wherein the control unit controls the braking force that acts on the mobile body from the ground surface by controlling the orientation of the mobile body and bringing the additional pad portion into contact with the ground surface.

(10)

The control apparatus according to any one of the items (1) to (9) above, wherein the wheel body is an omni wheel.

(11)

The control apparatus according to any one of the items (1) to (10) above, wherein the wheel body is connected to each of the leg portions by an elastic member.

(12)

The control apparatus according to any one of the items (1) to (11) above, wherein a direction of a movable shaft of the joint is the pitch axis direction of the mobile body.

(13)

The control apparatus according to any one of the items (1) to (12) above, wherein the mobile body includes four or more leg portions.

(14)

A control method including

controlling, with a computing unit, an orientation of a mobile body that includes a plurality of leg portions each including at least one joint,

each of the leg portions having;

a wheel body that is provided at a leading end of the leg portion and grounds the leg portion; and a pad portion that is provided on at least one side face of the wheel body and has a higher frictional resistance with respect to a ground surface than that of the wheel body,

wherein a braking force that acts on the mobile body from the ground surface is controlled by controlling orientations of the leg portions in a pitch axis direction of the mobile body.

### REFERENCE SIGNS LIST

1 Leg type robot
2 Leg-wheel type robot
10, 20 Leg portion
12, 22 Body portion
29 Control apparatus
131, 231 Wheel
132, 232 Omni wheel
241 Elastic member
251, 252, 253 Additional pad portion
291 Movement control unit
292 Orientation control unit
293 Drive control unit
1321, 2321 Shaft portion
1322, 2311 Wheel body
1323, 2323 Small roller
2312, 2314, 2324 Pad portion

1. A control apparatus comprising
a control unit that controls an orientation of a mobile body equipped with a plurality of leg portions each including at least one joint,
each of the leg portions having;
a wheel body that is provided at a leading end of the leg portion and grounds the leg portion; and
a pad portion that is provided on at least one side face of the wheel body and has a higher frictional resistance with respect to a ground surface than that of the wheel body, wherein
the control unit controls a braking force that acts on the mobile body from the ground surface by controlling orientations of the leg portions in a pitch axis direction of the mobile body.

2. The control apparatus according to claim 1, wherein
a cross-sectional shape of the pad portion along any section perpendicular to a roll axis of the mobile body is a substantially semi-circular shape or a substantially fan shape.

3. The control apparatus according to claim 2, wherein
the cross-sectional shape of the pad portion along the section is a shape in which a portion of an arc of the substantially semi-circular shape or the substantially fan shape is replaced with a straight line perpendicular to the ground surface.

4. The control apparatus according to claim 3, wherein
a shape of the pad portion is a shape obtained by cutting out a portion of a curved face of a hemisphere along a plane perpendicular to the roll axis of the mobile body.

5. The control apparatus according to claim 1, wherein
a frictional resistance on a surface of the pad portion varies in accordance with a distance from the wheel body.

6. The control apparatus according to claim 5, wherein
the frictional resistance on the surface of the pad portion is larger on a side further away from the wheel body.

7. The control apparatus according to claim 5, wherein
a surface shape of the pad portion varies in accordance with the distance from the wheel body.

8. The control apparatus according to claim 1, wherein
the control unit controls the braking force that acts on the mobile body from the ground surface by swinging the leg portions in the pitch axis direction of the mobile body and bringing the pad portion into contact with the ground surface.

9. The control apparatus according to claim 1, further comprising
an additional pad portion on a body portion or each of the leg portions of the mobile body, wherein
the control unit controls the braking force that acts on the mobile body from the ground surface by controlling the orientation of the mobile body and bringing the additional pad portion into contact with the ground surface.

10. The control apparatus according to claim 1, wherein
the wheel body is an omni wheel.

11. The control apparatus according to claim 1, wherein
the wheel body is connected to each of the leg portions by an elastic member.

12. The control apparatus according to claim 1, wherein
a direction of a movable shaft of the joint is the pitch axis direction of the mobile body.

13. The control apparatus according to claim 1, wherein
the mobile body includes four or more leg portions.

14. A control method comprising
controlling, with a computing unit, an orientation of a mobile body that includes a plurality of leg portions each including at least one joint,
each of the leg portions having;
a wheel body that is provided at a leading end of the leg portion and grounds the leg portion; and
a pad portion that is provided on at least one side face of the wheel body and has a higher frictional resistance with respect to a ground surface than that of the wheel body, wherein
a braking force that acts on the mobile body from the ground surface is controlled by controlling orientations of the leg portions in a pitch axis direction of the mobile body.
